(19) United States
(12) Patent Application Publication
(10) Pub. No.: US 2025/0084957 A1
(43) Pub. Date: Mar. 13, 2025

(54) ATTACHMENT BASE FOR MOUNTING HARDWARE

(71) Applicant: AFFIXD, LLC, Atlanta, GA (US)

(72) Inventor: Cy E. MARTINEZ, Decatur, GA (US)

(73) Assignee: AFFIXD, LLC, Atlanta, GA (US)

(21) Appl. No.: 18/830,816

(22) Filed: Sep. 11, 2024

Related U.S. Application Data
(60) Provisional application No. 63/582,108, filed on Sep. 12, 2023.

(51) Int. Cl. F16M 11/10; F16M 13/02

(52) U.S. Cl. CPC F16M 11/10; F16M 13/02

(57) ABSTRACT

The present disclosure is directed to an attachment base for mounting hardware. One general aspect includes a mounting assembly for attaching an add-on to a display device. The mounting assembly also includes an attachment base configured to be positioned between a display device and a support structure, the attachment base may include a plurality of attachment base holes and one or more attachment base slots, where the attachment base is configured to receive one or more coupling elements that secure the attachment base to the display device and the support structure without requiring a complete disassembly of the display device from the support structure.

### CROSS-REFERENCE TO RELATED APPLICATIONS

This application claims the benefit of and priority to U.S. Provisional Patent Application No. 63/582,108, titled “Attachment Base for Mounting Hardware,” filed Sep. 12, 2023, the entire contents of which are hereby incorporated by reference herein.

### BACKGROUND

A peripheral is a device that is connected to a computer to expand its capabilities and provide additional functionality. Peripherals provide basic input and output operations with the computer but are not integral parts of the core computer system. Examples of peripherals include input devices such as keyboards, mice, scanners, webcams, and microphones, output devices such as monitors, printers, and speakers, and storage devices such as external hard drives, disk drives, and flash drives. Peripherals are designed to perform specific functions by interacting directly with the computer's processing unit and often rely on drivers or software to function properly.

Accessories, on the other hand, are devices or items that complement a computer but are not necessary for its basic operation. Accessories typically enhance the user experience, provide additional convenience, or offer aesthetic or protective features. Examples of accessories include adjustable laptop stands and mounts, portable power banks and charging stations, cable management solutions, mobile carts with or without storage compartments, screen protectors, and privacy screens.

Mounting add-ons such as peripherals and accessories directly onto a display device, such as a television, monitor, screen, or the like, is increasingly common in both residential and commercial environments. These add-ons enable users to interact more conveniently with the display device or perform additional functions, but also pose challenges in terms of storage, accessibility, and cleanliness.

In environments like hospitals or laboratories, for instance, there is often a need to keep work surfaces clear of clutter to maintain sterility and prevent contamination. Display devices are frequently mounted on carts or mobile workstations, which are moved between different locations, necessitating that any add-ons travel with the display devices. Traditional attachment bases may require complete disconnection of all attached cables and the removal of the display device from its mount to facilitate the installation or removal of an add-on. This process is not only time-consuming but also increases the risk of damage to the display device and/or the add-on. Additionally, existing attachment bases are often compatible only with add-ons, limiting their utility and requiring multiple bases for different peripherals or accessories.

### BRIEF SUMMARY OF THE INVENTION

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

The present disclosure is directed to an attachment base for mounting hardware. One general aspect includes a mounting assembly for attaching an add-on to a display device. The mounting assembly also includes an attachment base configured to be positioned between a display device and a support structure, the attachment base may include a plurality of attachment base holes and one or more attachment base slots, where the attachment base is configured to receive one or more coupling elements that secure the attachment base to the display device and the support structure without requiring a complete disassembly of the display device from the support structure.

The mounting assembly where the one or more attachment base slots are elongated openings extending from an edge of the attachment base towards a central portion of the attachment base. The attachment base is configured to accommodate multiple types of add-ons. The attachment base is further configured to allow installation and removal by sliding the attachment base over partially loosened coupling elements. The attachment base is made from a metal, a plastic, or a composite. The mounting assembly may include an add-on mount attachable to the attachment base. The add-on mount may include additional attachment holes configured to support various add-ons. The add-on mount is adjustable in both vertical and horizontal directions relative to the attachment base. The add-on mount is configured to support the add-on. The attachment base holes are arranged in a grid pattern. The mounting assembly may include reinforcement around one or more edges of the one or more attachment base slots to prevent wear and deformation during repeated installations and removals. The support structure may include a mount with a standardized configuration of mounting holes.

One general aspect includes a method for installing an add-on onto a display device. The method also includes forming a gap between the display device and a support structure by partially loosening one or more coupling elements. The method also includes inserting an attachment base between the display device and the support structure, the attachment base may include a plurality of attachment base holes and one or more attachment base slots configured to align with the one or more coupling elements. The method also includes tightening the one or more coupling elements to compress the attachment base between the display device and the support structure, securing the attachment base without requiring a complete disassembly of the display device from the support structure.

Implementations may include one or more of the following features. The method may include aligning the attachment base slots with the partially loosened coupling elements before inserting the attachment base into the gap. The method may include attaching an add-on mount to the attachment base, the add-on mount being configured to support the add-on. The add-on mount is adjustable relative to the attachment base to allow repositioning of the add-on. The method may include positioning an accessory arm on the attachment base, the accessory arm may include additional attachment holes for securing various add-ons.

One general aspect includes a mounting system for attaching one or more add-ons to a display device. The mounting system also includes an attachment base configured to be installed between a display device and a support structure, the attachment base having a plurality of attachment base holes and one or more attachment base slots configured to receive coupling elements. The system also includes an accessory arm attachable to the attachment base, the accessory arm may include additional attachment holes for securing the one or more add-ons. The system also includes an add-on mount attachable to the attachment base, the add-on mount may include multiple mount slots and holes for versatile attachment of the one or more add-ons. The system also includes where the attachment base, the accessory arm, and the add-on mount allow for versatile mounting of the one or more add-ons without requiring a complete disassembly of the display device from the support structure.

Implementations may include one or more of the following features. The mounting system where the add-on mount is configured to be attached above, below, or to a side the display device to support the one or more add-ons in various positions. The attachment base may include one or more cable management elements to organize and secure one or more cables. The add-on mount may include a quick-release mechanism to facilitate easy installation and removal of peripheral devices.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A-1F depict various views of an attachment base installed between a monitor and a monitor support structure according to an example implementation.

FIGS. 2A-2D depict various views of an attachment base according to an example implementation.

FIGS. 3A-3D depict various views of an accessory arm installed onto an attachment base and a scanner mount installed onto the accessory arm according to an example implementation.

FIGS. 4A-4D depict various views of the configuration shown in FIGS. 3A-3D with a scanner base and a scanner installed according to an example implementation.

FIGS. 5A-5D depict various views of an accessory arm and a camera mount installed onto an attachment base and a scanner mount installed onto the accessory arm according to an example implementation.

FIGS. 6A-6F depict various views of the configuration shown in FIGS. 5A-5D with a scanner base, a scanner, and a camera installed according to an example implementation.

FIGS. 7A-7E depict various views of an attachment base, an accessory arm, and a scanner mount according to an example implementation.

FIG. 8 depicts a method for installing an attachment base onto a monitor and securing various add-ons thereto according to an example implementation.

### DETAILED DESCRIPTION

The present disclosure relates to an attachment base for mounting hardware that addresses significant challenges in the field of display device and add-on management. Conventionally, mounting add-ons such as keyboards, remote controls, medical devices, and other add-ons directly onto display devices required complex installations and often necessitated the complete removal of the display device from its mount. This process can be cumbersome, time-consuming, and risk damaging the display device or its mounting hardware, especially in environments where frequent adjustments or reconfigurations are necessary, such as in hospitals, retail spaces, or trade shows. Furthermore, conventional attachment bases were often limited in compatibility, supporting only specific add-ons, and requiring different bases for each new add-on.

The disclosed attachment base provides a versatile and user-friendly solution to these problems. The disclosed attachment base is designed to be easily inserted between an existing mount and a mounted object, such as a monitor or other display device, without the need for complete disassembly or detachment. The attachment base includes connection elements like slots that align with the existing mounting hardware, allowing the attachment base to slide into place without removing all or at least a portion of the coupling elements. This design facilitates the quick and secure addition or removal of various add-ons directly onto the display mount, significantly reducing installation time and the risk of damage to equipment. The attachment base can accommodate multiple types of add-ons, thus providing a versatile solution for environments where flexibility and rapid reconfiguration are needed.

The disclosed attachment base provides several advantages over existing solutions. The attachment base offers a simplified installation process that does not require the complete removal of the display or detachment from its mount, reducing labor costs and minimizing downtime. The attachment base is compatible with a wide range of accessories through standardized mounting configurations like Video Electronics Standards Association (VESA®) allows for greater flexibility and reduces the need for multiple attachment bases. Additionally, the attachment base may be manufactured from various materials to suit different environments and usage requirements, from lightweight plastic for portable applications to durable metals for heavy-duty use. By providing a universal, easy-to-install, and secure solution for installing add-ons, the disclosed attachment base meets the evolving needs of users across various industries, enhancing both functionality and efficiency.

The present disclosure may be understood more readily by reference to the following detailed description of example implementations taken in connection with the accompanying drawing figures, which form a part of this disclosure. It is to be understood that this disclosure is not limited to the specific devices, methods, conditions, or parameters described and/or shown herein, and that the terminology used herein is for the purpose of describing particular implementations by way of example only and is not intended to be limiting of the claimed disclosure.

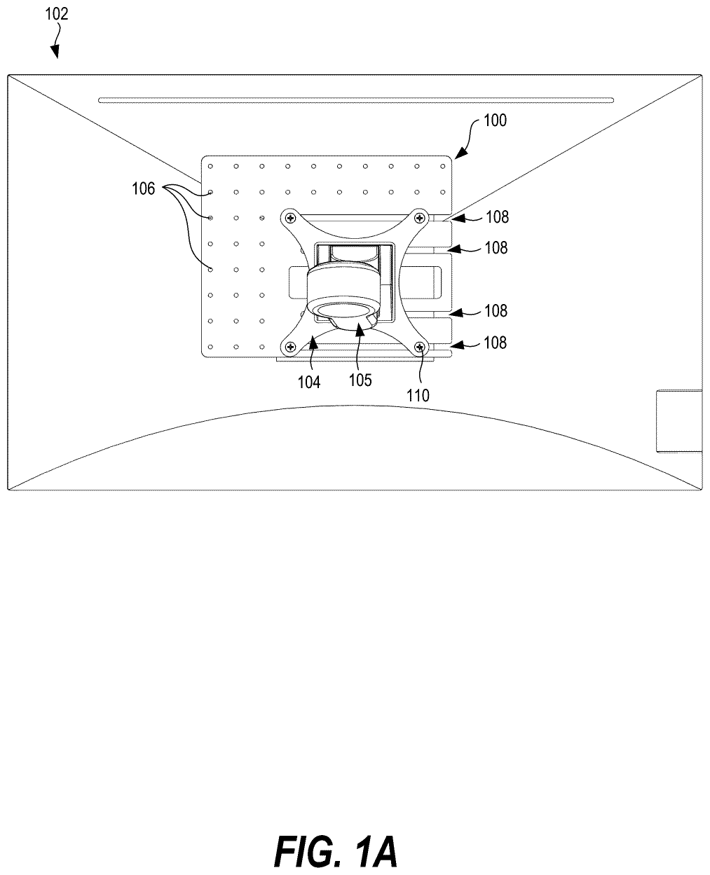

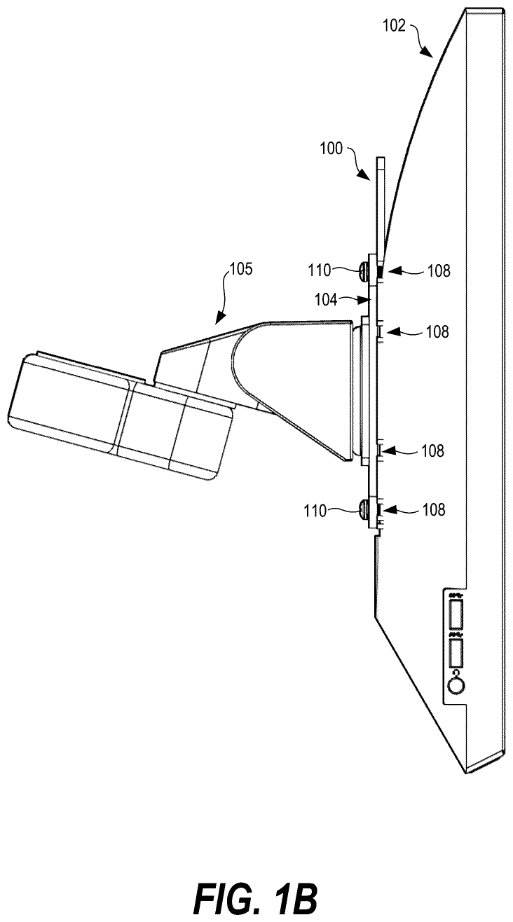

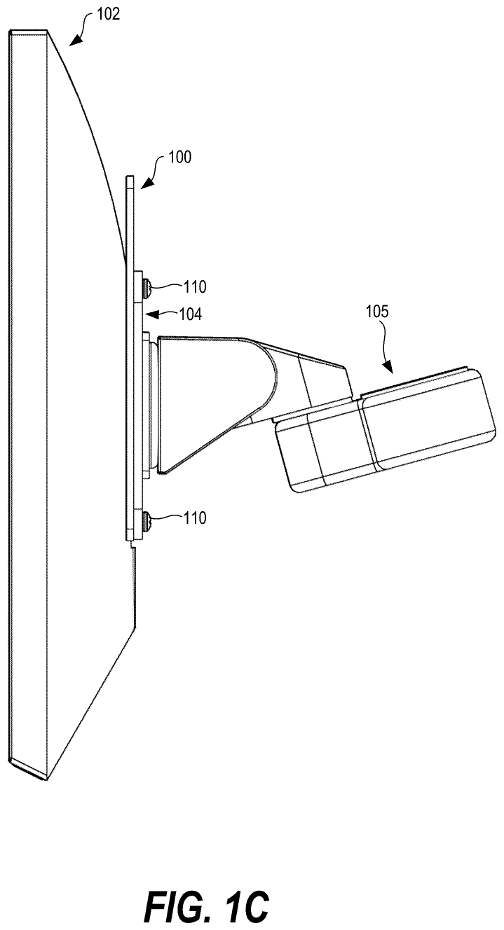

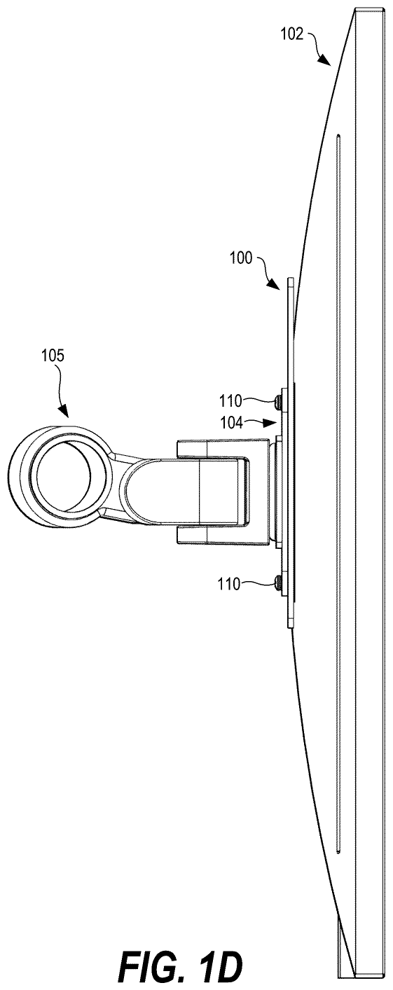

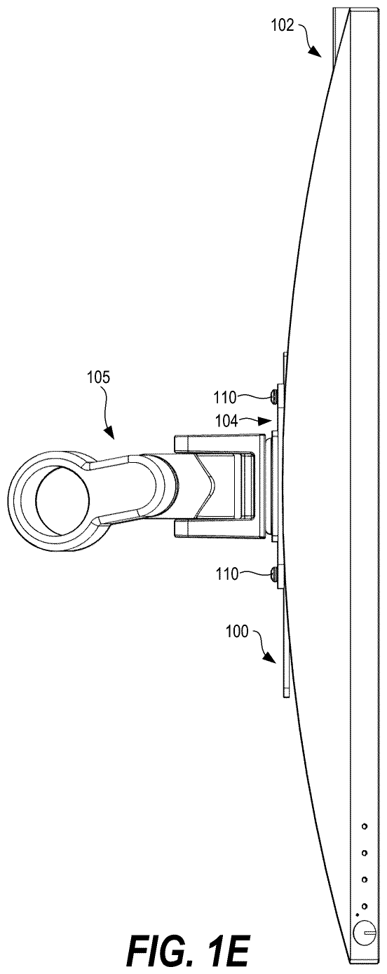

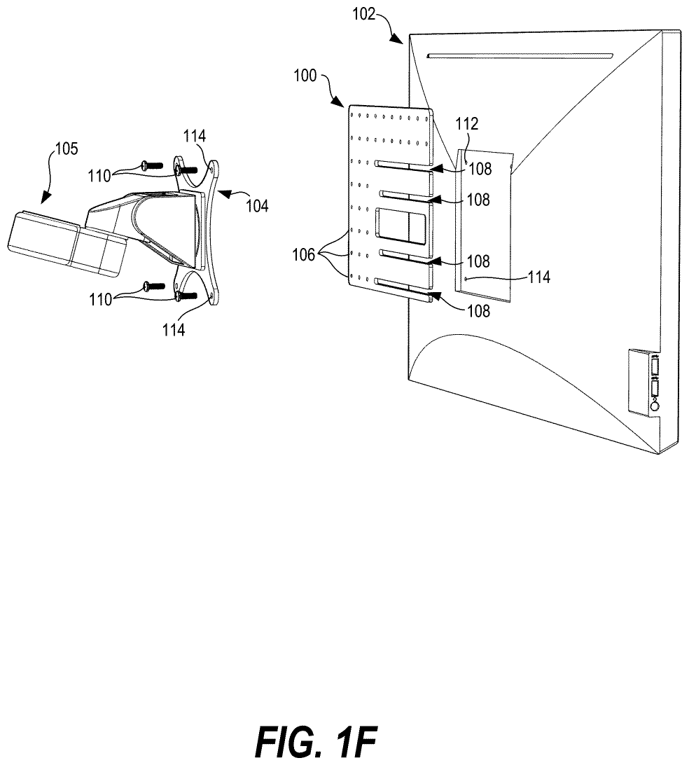

Referring now to FIG. 1A, shown is a back view of an example implementation of an attachment base 100 in use with a monitor 102 or other display device (e.g., a television or screen). The monitor 102 is representative of a variety of display devices used in different settings, providing flexibility in application. The attachment base 100 is securely mounted between the monitor 102 and a support structure 104 facilitating the attachment of various add-ons (i.e., peripherals and/or accessories) to the monitor 102.

The attachment base 100 may be manufactured from various materials, such as anodized aluminum for lightweight applications, stainless steel for corrosion resistance in outdoor or industrial environments, and high-strength plastic for economical and lightweight setups in educational settings. Each material choice impacts the overall weight, flexibility, and durability of the attachment base 100, allowing customization based on the intended use case.

In a hospital setting, the monitor 102 may be a medical-grade monitor attached to or set upon a mobile workstation or cart. Medical-grade monitors are typically used to display patient information, medical imaging, or serve as a user interface for electronic health record systems. The attachment base 100 allows for mounting add-ons such as barcode scanners (e.g., to scan patient bracelets, medicine, and/or other barcodes), vital sign monitors, or portable keyboards, ensuring that these tools are readily accessible to healthcare professionals while maintaining a sterile environment.

In retail environments, the monitor 102 may be a point-of-sale (POS) display. The attachment base 100 may provide mounting options for add-ons such as credit card readers, receipt printers, or customer-facing displays. This setup enhances the functionality of a POS system by keeping all add-ons within easy reach of the user while minimizing counter space usage.

In educational institutions or office settings, the monitor 102 may be a standard computer monitor used in classrooms, conference rooms, or at desks. The attachment base 100 allows for the addition of add-ons such as webcams, document cameras, or microphone arms, enabling more interactive and flexible learning or presentation environments. This setup is particularly useful in hybrid or remote learning environments, where additional equipment needs to be integrated with the primary display setup.

In industrial or manufacturing environments, the monitor 102 may be a ruggedized monitor used to display real-time data, instructions, or controls for machinery. The attachment base 100 may be used to securely mount tools, sensors, or control panels needed by workers operating machinery or monitoring production lines. The ability to attach these add-ons to the monitor 102 helps streamline workflows and reduce the risk of equipment damage or misplacement.

In gaming setups or home entertainment systems, the monitor 102 may be a high-definition or curved gaming monitor. The attachment base 100 may be used to attach peripherals such as game controllers, headphones, or streaming equipment like cameras and microphones. This enhances the gaming experience by providing easy access to equipment without cluttering the gaming area.

The support structure 104 is a stable component designed to securely attach the monitor 102 or the display device to a fixed surface like a wall, desk, ceiling, mobile workstation, cart, and so on. The support structure 104 may be or may include one or more mounting plates such as VESA® plates, which have standardized hole patterns to ensure compatibility with a wide range of monitors and mounting hardware. The support structure 104 provides a reliable foundation for mounting, ensuring that the monitor 102 remains securely positioned while allowing for various adjustments.

The attachment base 100 may be installed between the monitor 102 and the support structure 104. This provides additional functionality by offering multiple attachment points for add-ons. A mount 105 may be installed onto the support structure 104. The support structure 104 and the mount 105 may be separate components as described or may be combined as a single component.

The mount 105 is an apparatus that attaches the monitor 102 to the support structure 104. The mount 105 may offer varying degrees of flexibility and adjustability depending on its design. The mount 105, for instance, may be a wall mount, an arm mount, or a stand mount, although other mount types are contemplated. As a wall mount, the mount 105 secures the monitor 102 directly to a wall and may provide adjustable components for tilting, swiveling, or otherwise manipulating the position of the monitor 102 on the mount 105. As an arm mount, the mount 105 attaches to the support structure 104 via an adjustable arm, allowing the monitor 102 to move freely and be repositioned as needed. As a stand mount, the mount 105 is set on a flat surface like a desk or mobile workstation, and optionally may be secured to the flat surface using bolts, screws, hook-and-loop material, adhesive, or the like, providing a free-standing solution with options for height adjustment and tilt. The mount 105 may designed to be easily removable from the support structure 104 using mechanisms like quick-release levers, slide-and-click systems, or screws, enabling convenient reconfiguration and maintenance.

The attachment base 100 is shown as a generally rectangular plate with a grid pattern of multiple attachment base holes 106 arranged in rows and columns. The attachment base 100 may be made from strong, durable materials such as anodized aluminum, steel, or high-strength plastics, which provide the necessary rigidity and strength to securely support attached accessories without bending or breaking under load. Additionally, the design of attachment base 100, including the distribution and size of the attachment base holes 106, may be optimized to distribute the load evenly across the mounting surface, further enhancing its secure attachment.

The design and spacing of the attachment base holes 106 may be optimized to minimize stress points and prevent warping under heavy loads, such as mounting a large medical monitor and attached accessories. The spacing between the attachment base holes 106 may vary depending on the intended application. Although the attachment base holes 106 are shown in a grid pattern, alternative patterns of the attachment base holes 106 or alternative arrangements of the attachment base holes 106 on the attachment base 100 are contemplated.

The attachment base holes 106 are designed to accommodate screws, bolts, pegs, or other coupling elements not shown in FIG. 1A, allowing for the flexible positioning of add-ons onto the attachment base 100. The attachment base 100 is positioned centrally on the back side of the monitor 102, aligning with the standardized mounting points typically found on display devices, such as those conforming to Video Electronics Standards Association VESA® standards. This ensures that the attachment base 100 can be easily positioned and aligned with the existing mounting holes on the monitor 102.

The attachment base 100 includes one or more attachment base slots 108 designed to facilitate easy installation and secure attachment to the monitor 102 and the support structure 104 without requiring complete disassembly of the existing setup. The attachment base slots 108 are elongated openings cut into the attachment base 100 that extend from one edge into a middle portion of the attachment base 100. The attachment base slots 108 are strategically placed to align with coupling elements 110 (e.g., screws, bolts, or pegs) that secure the monitor 102 to the support structure 104. In the illustrated example, four coupling elements 110 are used, but the number of coupling elements 110 may vary depending on the application. This alignment allows the attachment base slots 108 to slide over the partially loosened coupling elements 110, enabling the attachment base 100 to be inserted between the monitor 102 and the support structure 104 without the need to completely remove the monitor 102 from the mount 105.

The primary function of the attachment base slots 108 is to provide a pathway through which the coupling elements 110 can pass, allowing the attachment base 100 to be positioned in place. During installation, the coupling elements 110 are partially unscrewed to create a gap between the monitor 102 and the support structure 104. The attachment base slots 108 then slide over the coupling elements 110, guiding the attachment base 100 into the correct position. Once the attachment base 100 is in place, the coupling elements 110 are tightened, securing the attachment base 100 against the monitor 102 and support structure 104.

The attachment base slots 108 may be configured in several shapes, such as T-slots, U-slots, or elongated slots, depending on the application. For example, T-slots may be used for tool-free adjustments in industrial settings, whereas U-slots could offer a tighter fit for medical applications where vibration resistance is critical.

The width and depth of the attachment base slots 108 are designed to accommodate the diameter of the coupling elements 110 while preventing lateral movement once installed. The ends of the attachment base slots 108 may be slightly enlarged or reinforced to act as stops, ensuring the attachment base 100 remains securely in place and does not shift under load or during movement. This design feature helps maintain the integrity and stability of the mounted setup, even in dynamic environments where the monitor 102 may be frequently adjusted or relocated.

The edges of the attachment base slots 108 may be reinforced with additional material, such as a high-strength polymer coating or a double-layered metal construction. This reinforcement helps to prevent wear and deformation over time, especially when the attachment base 100 is frequently installed or removed. For example, in healthcare environments where equipment must be sterilized regularly, a reinforced slot edge prevents degradation from repeated cleaning with harsh disinfectants.

The attachment base slots 108 make it easy to install or remove the attachment base 100 without the need to completely disassemble the monitor 102 and the support structure 104 setup. This feature is particularly useful in environments where display devices need to be frequently reconfigured or where minimal downtime is critical, such as in medical settings or retail environments. Additionally, the presence of multiple attachment base slots 108 allows for flexibility in positioning the attachment base 100, accommodating different sizes and types of monitors 102 and support structures 104.

The attachment base slots 108 may be reinforced with additional material around the edges to prevent wear or deformation over time. In some implementations, the attachment base slots 108 may be lined with a softer material or coating to reduce friction and protect the coupling elements 110 and the attachment base 100 from damage during installation and removal.

The attachment base 100 is held securely in place by the compressive force created when the coupling elements 110 are tightened. This compression fit not only prevents movement or shifting of the attachment base 100 but also adds to the overall structural stability of the mounted setup, even when the monitor 102 is subject to movement or vibration, such as in mobile workstations or carts.

Turning to FIGS. 1B and 1C, shown are side views of an example implementation of the attachment base 100 in use with the monitor 102. In these views, the attachment base 100 is installed between the monitor 102 and the support structure 104, demonstrating the integration of these components. The support structure 104 is securely connected to the monitor 102 through the coupling elements 110, which pass through the attachment base slots 108. The attachment base slots 108 allow for easy alignment and secure attachment of the monitor 102 to the support structure 104 without the need for complete disassembly.

FIG. 1B specifically illustrates the attachment base 100 from a left side perspective, showing the coupling elements 110 extending through the attachment base slots 108, which are strategically designed to accommodate various mounting configurations. This configuration ensures that the attachment base 100 remains firmly in place while supporting the monitor 102.

FIG. 1C presents a right side view further emphasizing the stable connection between the attachment base 100, the monitor 102, and the support structure 104. Additionally, these figures highlight the overall compact design of the assembly, which minimizes protrusion from the monitor 102, maintaining a sleek and functional setup that is suitable for various environments. The mount 105, attached to the support structure 104, is also shown to provide flexible positioning for the monitor 102, enhancing its utility and ergonomic adaptability in different usage scenarios.

Turning to FIG. 1D, shown is a top-down view of an example implementation of the attachment base 100 used with the monitor 102 and the support structure 104. In this configuration, the attachment base 100 is shown positioned between the monitor 102 and the support structure 104, which is connected to the mount 105. FIG. 1D illustrates how the coupling elements 110 pass through the support structure 104 and the attachment base 100, securing the monitor 102 in place. The top-down perspective highlights the alignment of the various components, showing the precise fit of the attachment base 100 relative to the monitor 102 and the support structure 104. The mount 105 is depicted extending outward, providing flexibility in positioning the monitor 102.

Turning to FIG. 1E, shown is a bottom view of an example implementation of the attachment base 100 mounted between the monitor 102 and the support structure 104. This perspective highlights the secure positioning of the attachment base 100 between the monitor 102 and the support structure 104, with coupling elements 110 extending through these components to ensure a stable connection.

In this view, the monitor 102 is mounted onto the support structure 104 using the attachment base 100, which is held in place by the coupling elements 110. The attachment base 100 is shown fixed between the monitor 102 and the support structure 104, which is shown as part of the mount 105. The mount 105 allows for adjustable positioning of the monitor 102, providing flexibility in orientation and movement.

The bottom view clearly shows how the attachment base 100 integrates with the monitor 102 and the support structure 104, emphasizing the strong and secure connection provided by the coupling elements 110. The design ensures that the monitor setup remains stable and can accommodate different accessories and adjustments, thereby enhancing the functionality and versatility of the display system.

Turning to FIG. 1F, shown is an exploded perspective view that illustrates the assembly of the attachment base 100 between the monitor 102 and the support structure 104. FIG. 1F shows the components separated to provide a clear view of how each part fits together in the assembly process.

On the right side of FIG. 1F, the monitor 102 is depicted with the attachment base 100 positioned in front of it. The attachment base 100 includes multiple attachment base holes 106 arranged in a grid pattern and several attachment base slots 108 designed to align with monitor holes 112 on the back of the monitor 102. The attachment base slots 108 allow the attachment base 100 to be securely mounted to the monitor 102 using coupling elements 110, which pass through the attachment base slots 108 and into the monitor holes 112.

On the left side of the figure, the support structure 104 is shown with the mount 105 attached. The support structure 104 features several support structure holes 114, which are intended to align with the attachment base slots 108 and the monitor holes 112. The coupling elements 110 are illustrated as they would be used to attach the support structure 104 to the monitor 102 with the attachment base 100 installed therebetween. Specifically, the coupling elements 110 pass through the support structure holes 114 and the attachment base slots 108 into the monitor holes 112.

The exploded view depicted in FIG. 1F emphasizes the modular nature of the design, allowing for easy assembly and disassembly of the components. The attachment base 100 provides a versatile platform for mounting various add-ons and is compatible with standardized mounting configurations like VESA. By separating the components, FIG. 1F highlights the alignment of the attachment base holes 106 and the attachment base slots 108, demonstrating how the assembly is securely held together with the coupling elements 110, ensuring stability and ease of use in various environments.

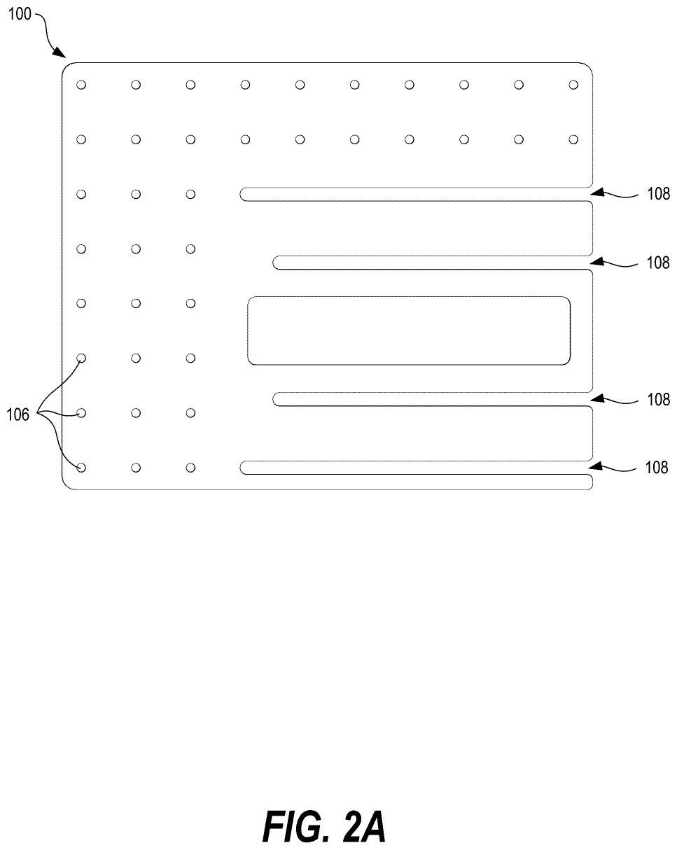

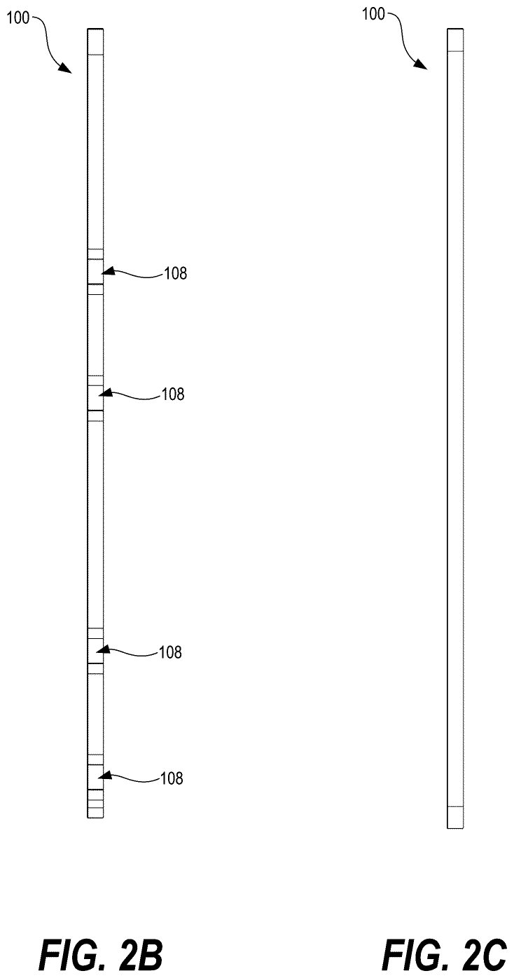

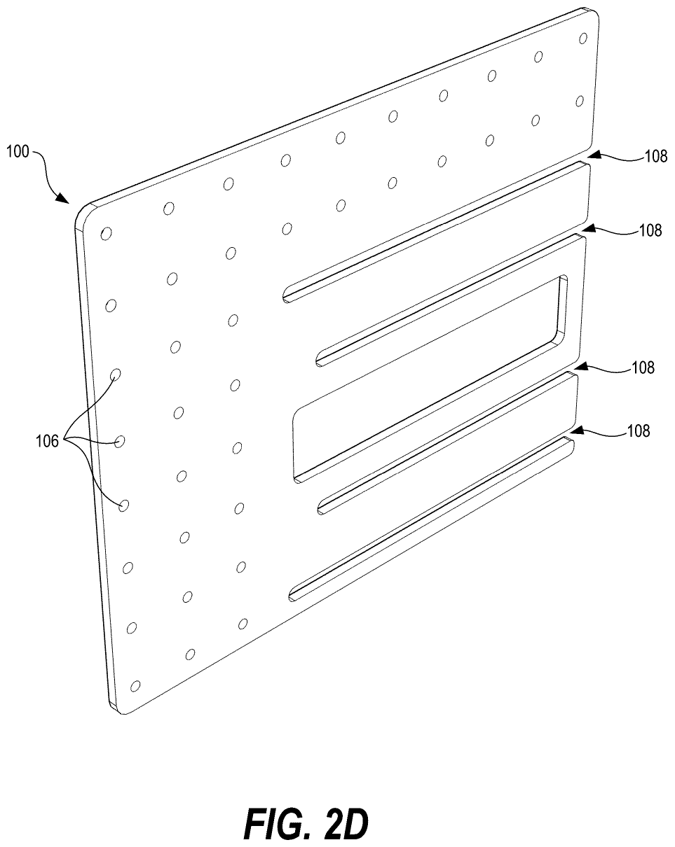

Turning to FIG. 2A, shown is a front view of the attachment base 100 according to an example implementation. The attachment base 100 is primarily a rectangular plate with a series of strategically placed attachment base holes 106 and attachment base slots 108 that enable versatile mounting options.

The grid pattern of the attachment base holes 106 is distributed across a significant portion of the attachment base 100. The attachment base holes 106 are arranged in evenly spaced rows and columns, designed to accommodate various coupling elements 110. This grid configuration allows for flexible positioning of add-ons on the attachment base 100, making the attachment base 100 adaptable to different devices and requirements.

In addition to the attachment base holes 106, the attachment base 100 features multiple attachment base slots 108. The attachment base slots 108 extend from one edge of the attachment base 100 towards its center, providing pathways for the coupling elements 110 used to secure the attachment base 100 between the monitor 102 and the support structure 104. The attachment base slots 108 are designed to allow easy alignment of the attachment base 100 with the monitor holes 112 on the back of the monitor 102 or other display, enabling quick and efficient installation without the need for complete disassembly.

The attachment base slots 108 may vary in size and shape, with some being longer and narrower while others are wider to accommodate different types of mounting hardware and configurations. The elongated design of the attachment base slots 108 permits a range of adjustment during installation, providing flexibility in positioning the attachment base 100 relative to the monitor 102 and the support structure 104. This flexibility is particularly useful for aligning with standardized mounting configurations, such as those specified by VESA®.

The overall design of the attachment base 100, with a combination of the attachment base holes 106 and the attachment base slots 108, ensures a robust and secure attachment to a variety of monitors 102 and support structures 104. The grid of attachment base holes 106 allows for a multitude of add-on arrangements, while the attachment base slots 108 provide adaptability in mounting, enhancing the functionality and versatility of the display setup. The rectangular shape of the attachment base 100 and the distribution of the attachment base holes 106 and the attachment base slots 108 contribute to the structural integrity of the attachment base 100, allowing the attachment base 100 to support various weights and types of add-ons without bending or warping under load.

Turning to FIGS. 2B and 2C, shown are side views of the attachment base 100. These figures highlight an example profile and placement of the attachment base slots 108 of the attachment base 100.

In particular, FIG. 2B shows a side view of the attachment base 100, focusing on the thickness of the attachment base 100 and the positioning of the attachment base slots 108 along one side of the attachment base 100. The attachment base slots 108 are depicted as cutouts within the attachment base 100. The cutouts extend from one edge towards the center. FIG. 2B illustrates how the attachment base slots 108 may be spaced apart vertically, allowing for multiple mounting points and providing flexibility in the alignment with the coupling elements 110 on the support structure 104. This view also emphasizes the uniform thickness of the attachment base 100, which contributes to its structural integrity while still allowing for easy installation between a monitor 102 and a support structure 104. It should be understood, however, that the attachment base 100 may have a thickness that is non-uniform, such as to reduce weight from areas that do not require reinforcement and other areas that require additional thickness for reinforcement. For instance, the area around the attachment base slots 108 may be thicker than other areas of the attachment base 100.

FIG. 2C provides an unobstructed side view of the attachment base 100 from the opposite edge from the edge shown in FIG. 2B, showing a continuous profile without interruptions. This perspective highlights the overall slim design of the attachment base 100 and the absence of attachment base slots 108 that extend edge-to-edge.

Turning to FIG. 2D, shown is a perspective view of the attachment base 100, illustrating its overall structure, including an example arrangement of the attachment base holes 106 and the attachment base slots 108. The attachment base 100 is depicted as a generally rectangular plate, featuring a grid pattern of multiple attachment base holes 106. The attachment base holes 106 are distributed across the surface of the plate in evenly spaced rows and columns, providing versatile attachment points for various accessories, although other configurations are contemplated. The attachment base holes 106 are designed to accommodate one or more coupling elements 110, allowing for secure mounting of add-ons onto the attachment base 100.

In addition to the attachment base holes 106, the attachment base 100 includes multiple attachment base slots 108, strategically placed to align with the coupling elements 110 that secure the attachment base 100 to the monitor 102 and the support structure 104. The attachment base slots 108 extend from the edge of the attachment base 100 towards the center, facilitating easy installation by allowing the attachment base 100 to be slid into place without needing to remove the monitor 102 or the support structure 104 completely. The attachment base slots 108 are designed to guide the coupling elements 110 into position during installation to ensure a secure fit once the coupling elements 110 are tightened.

The perspective view of FIG. 2D highlights the flat, slim profile of the attachment base 100 in one example implementation. This demonstrates that the attachment base 100 is suitable for applications where maintaining a low profile is desired. The combination of multiple attachment base holes 106 and attachment base slots 108 provides flexibility in mounting various add-ons, making the attachment base 100 adaptable to different configurations, environments, and use cases.

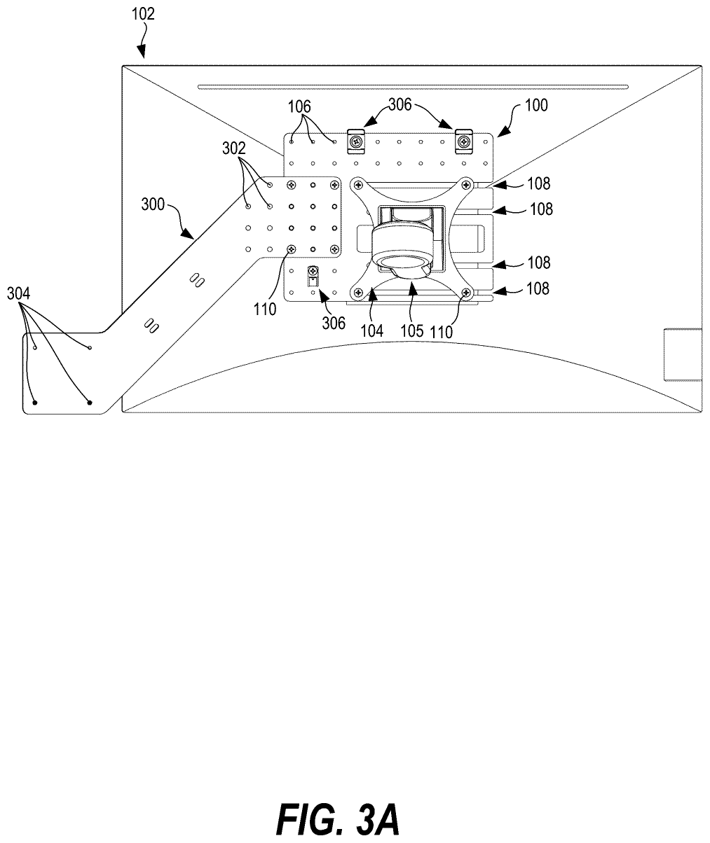

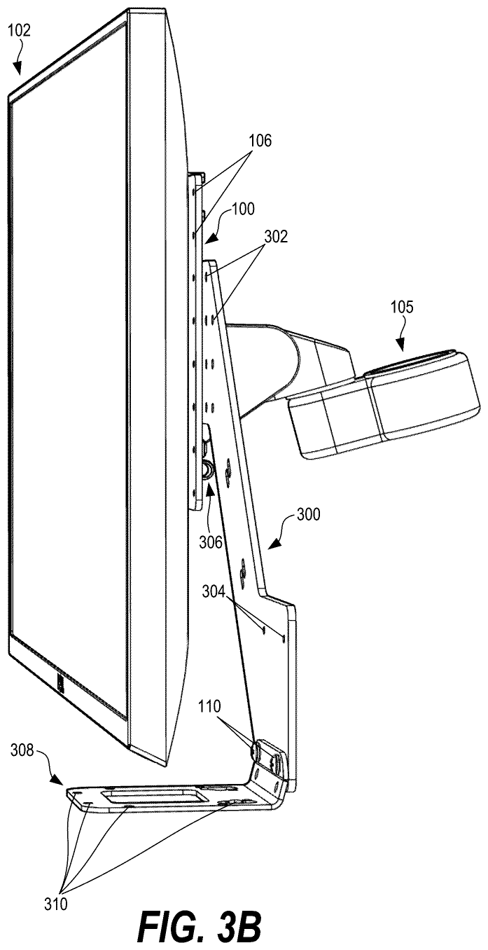

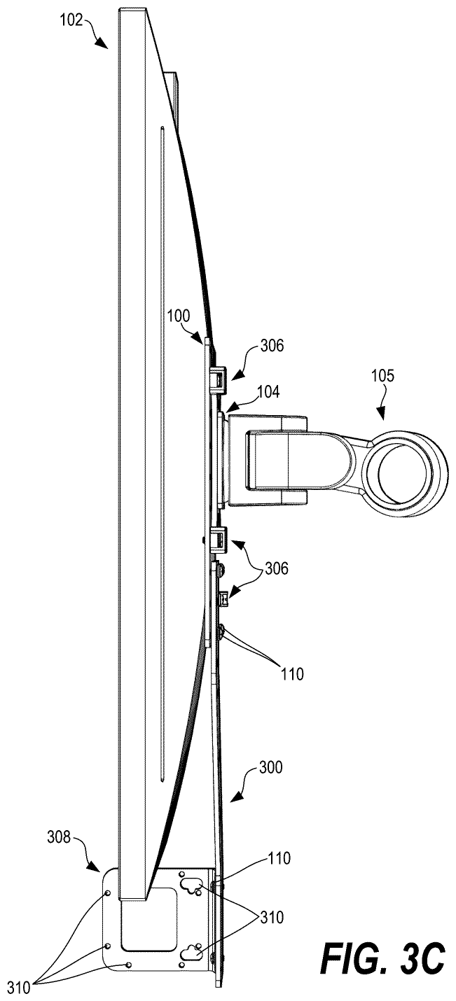

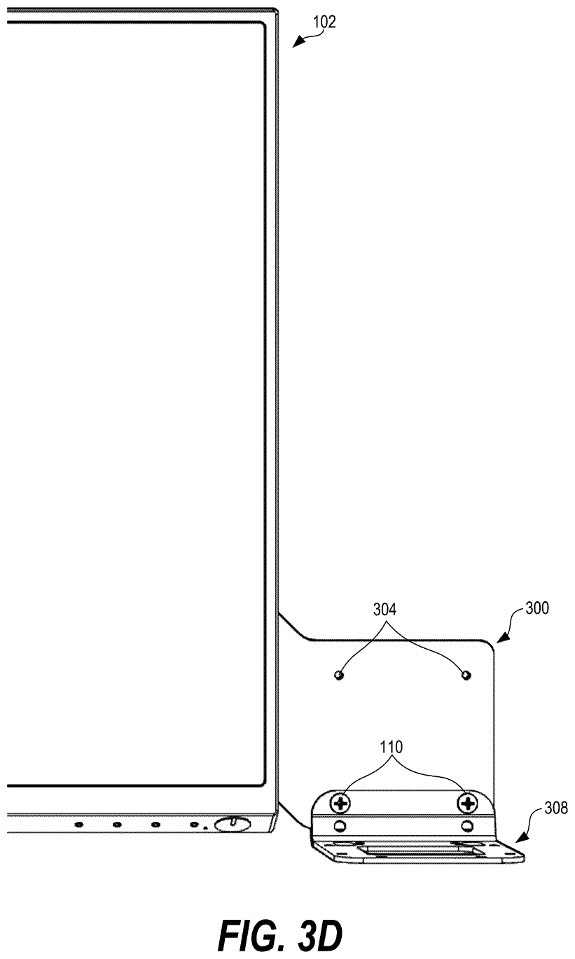

Turning to FIG. 3A, shown is a back view of an attachment system where the attachment base 100 is mounted to the monitor 102, and an accessory arm 300 is secured to the attachment base 100. This configuration illustrates the integration of multiple components designed to support various add-ons.

The attachment base 100 is centrally positioned on the back of the monitor 102 and includes a grid of the attachment base holes 106 and the attachment base slots 108, in a configuration such as described above. An accessory arm 300 is shown extending from the attachment base 100. The accessory arm 300 is fastened using several coupling elements 110 through accessory arm holes 302, which are aligned with the corresponding attachment base holes 106 on the attachment base 100. The accessory arm 300 includes additional attachment holes 304 near its end, providing flexibility for mounting various add-ons such as scanners, cameras, or other peripheral devices and/or additional mounts.

The support structure 104 is also depicted, attached to the attachment base 100 using the coupling elements 110. These coupling elements 110 ensure that the monitor 102 is securely held in place against the attachment base 100. The attachment base slots 108 on the attachment base 100 align with these coupling elements 110, allowing for easy installation and adjustment without requiring complete disassembly.

Additionally, wire management elements 306 are present on the attachment base 100. The wire management elements 306 help organize and secure cables (e.g., power, video, network, and so on), preventing tangling and maintaining a neat and efficient workspace.

FIG. 3B is a side perspective view of the attachment system, highlighting the lower end of the accessory arm 300 on which a scanner mount 308 is installed. The scanner mount 308 is attached to the accessory arm 300 using coupling elements 110 that pass through the attachment holes 304 on the accessory arm 300. Additionally, FIG. 3B demonstrates the ergonomic design of the mounting system, which allows the accessory arm 300 and the scanner mount 308 to be adjusted both vertically and horizontally. This adjustability is facilitated by the accessory arm holes 302 and the flexible design of the accessory arm 300, which can accommodate different angles and positions as required by the user.

The scanner mount 308 is particularly highlighted in FIG. 3B, showing the integration of scanner mount holes 310 that secure a scanner base firmly in place while allowing for easy detachment and repositioning. This modular approach to accessory mounting ensures that the system can adapt to various use cases, from healthcare to retail, by supporting a range of peripheral devices. Thus, although a scanner mount 308 is described, the scanner mount 308 may be used with other add-ons such as cameras, microphones, and so on. In this manner, the scanner mount 308 in some implementations is a universal mount configured to mount any number or type of add-ons onto the accessory arm 300.

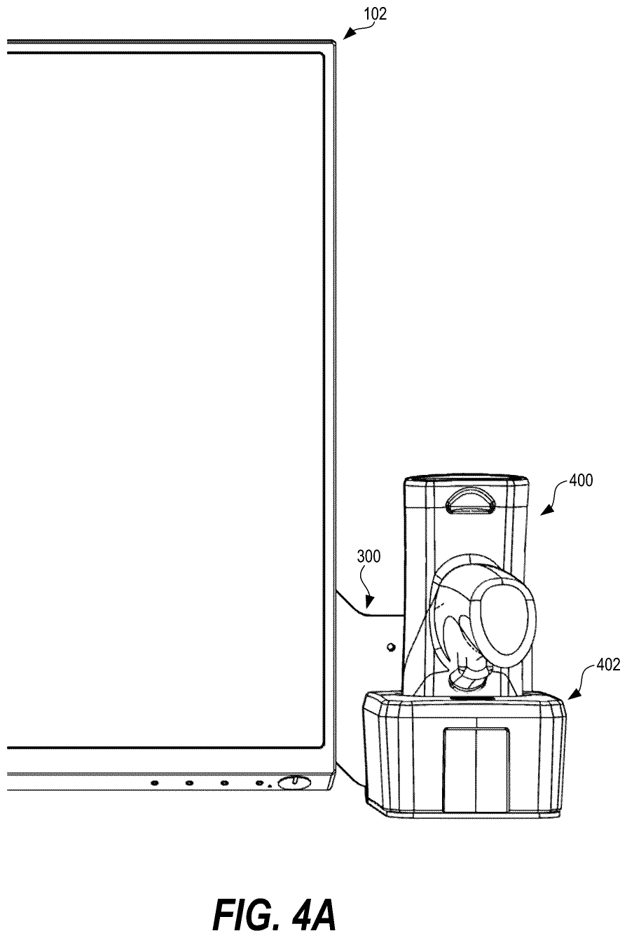

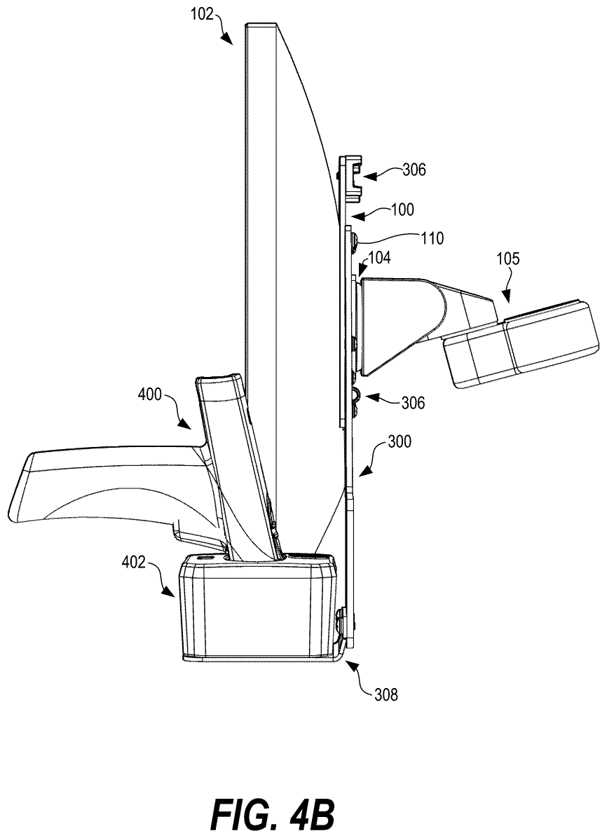

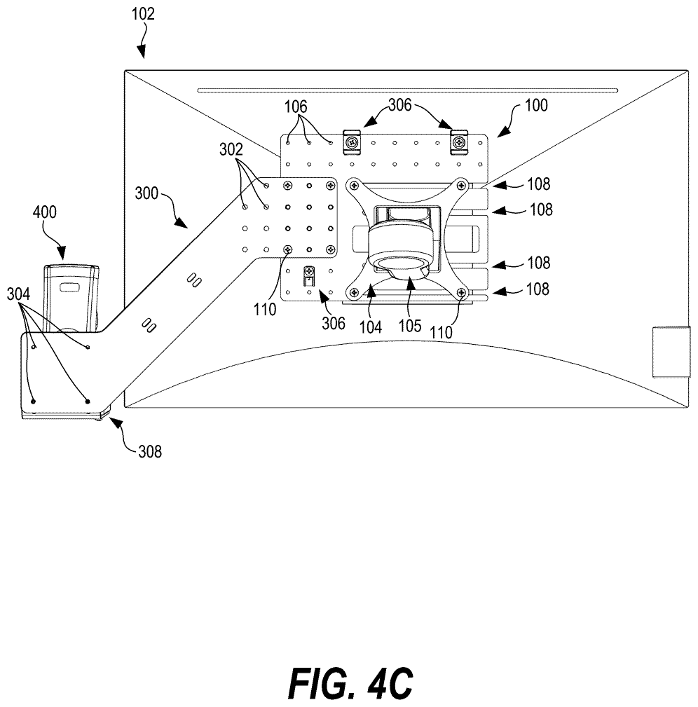

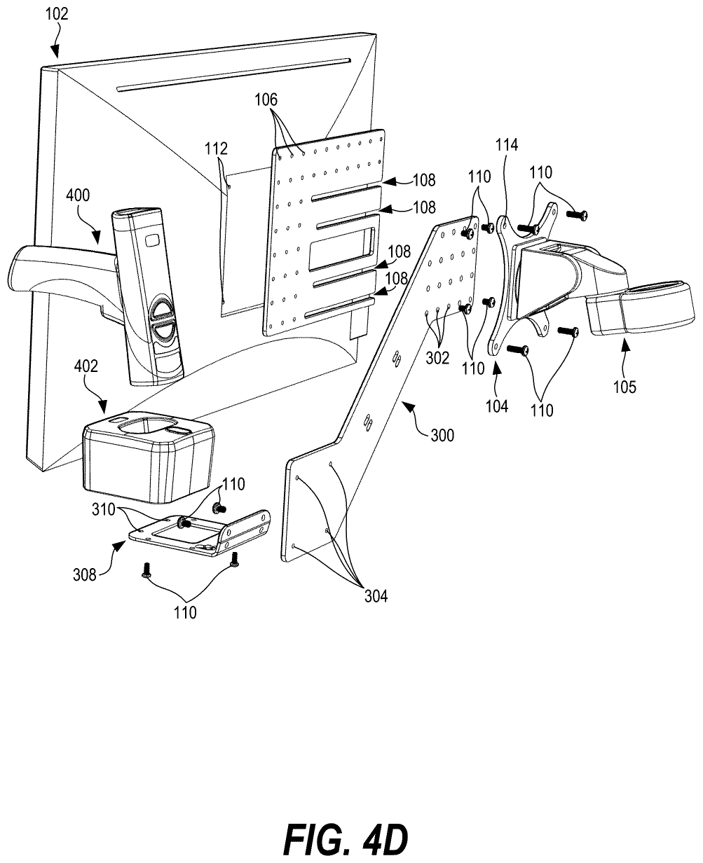

Additional details of the scanner mount 308 are shown in FIGS. 3C and 3D, which illustrate the configuration of the scanner mount 308 and the scanner mount holes 310. The scanner mount 308 is depicted as a structural component designed to attach securely to the attachment base 100 via the accessory arm 300 as shown or directly (not shown). The scanner mount 308 includes multiple scanner mount holes 310 that are used to align and secure a scanner base (shown as 402 in FIGS. 4A, 4B, and 4D) to the scanner mount 308. In FIG. 3C, shown is a top view of how the scanner mount 308 is positioned in relation to the monitor 102 and the attachment base 100. The scanner mount holes 310 are visible, indicating where coupling elements 110 such as screws or bolts may be used to attach the a scanner base 402 (or other add-on) to the scanner mount 308. In FIG. 3D, shown is a zoomed in front view, emphasizing the positioning of the scanner mount 308 in relation to the monitor 102.

Turning to FIGS. 4A-4D, shown are various views of the scanner mount 308 with a scanner base 402 attached and holding a scanner 400. These figures demonstrate how the scanner mount 308 may accommodate the scanner base 402, which is securely attached to the scanner mount using appropriate fastening mechanisms through the scanner mount holes 310. This setup ensures a stable and reliable attachment for the scanner 400, allowing it to be positioned optimally for user access and functionality, such as to a side of the monitor 102 as shown in the illustrated example.

FIG. 4A depicts a front view of the scanner mount 308 with the scanner base 402 attached. FIG. 4A highlights the alignment of the scanner base 402 with the scanner mount 308, showing how the scanner base 402 fits securely on the scanner mount 308 to provide a stable platform for the scanner 400. The design allows for easy installation and removal of the scanner 400 while ensuring it remains firmly in place during operation.

FIG. 4B depicts a side view of the same configuration as shown in FIG. 4A, emphasizing the height and depth configuration of the scanner 400 relative to the scanner mount 308. This view particularly illustrates the ergonomic design of the scanner mount 308, allowing the scanner 400 to be angled appropriately for user comfort and accessibility. FIG. 4B also shows how the scanner base 402 is securely fastened to the scanner mount 308, ensuring stability even when the scanner is frequently used or adjusted.

FIG. 4C depicts a rear view of the scanner 400 and scanner base 402 installed in the scanner mount 308, demonstrating the seamless integration of these components. FIG. 4C highlights the structural support provided by the scanner mount 308 and how it facilitates the secure placement of the scanner 400.

FIG. 4D depicts an exploded perspective view of the entire assembly, highlighting the scanner mount 308, the scanner base 402, and the scanner 400. This view provides a comprehensive look at how the components are configured together, emphasizing the modularity and flexibility of this configuration. This view also illustrates the ease with which the scanner base 402 can be removed or replaced, making the system adaptable to various user needs and applications.

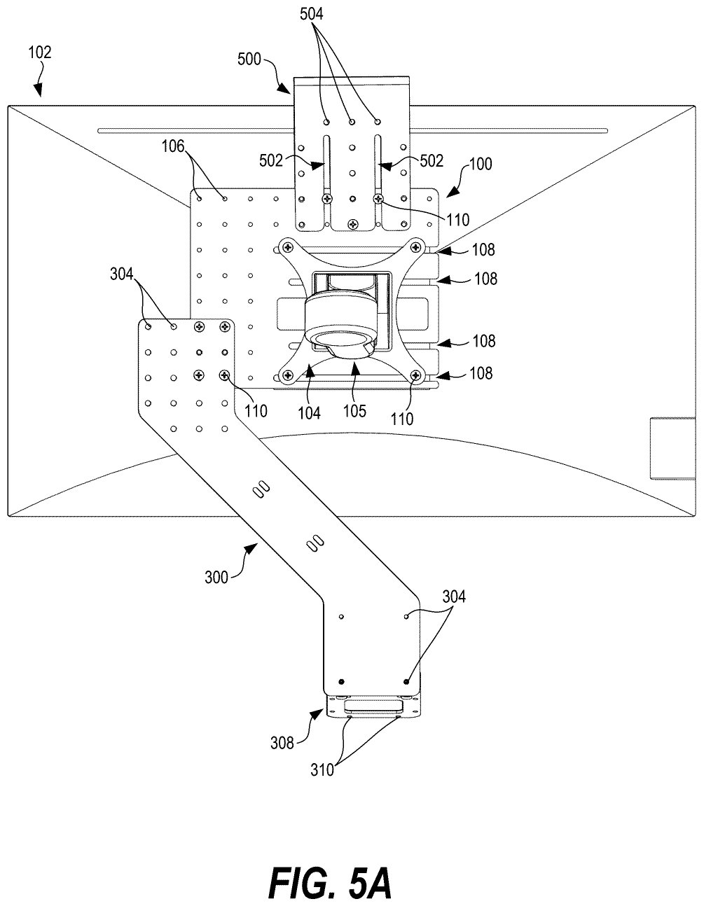

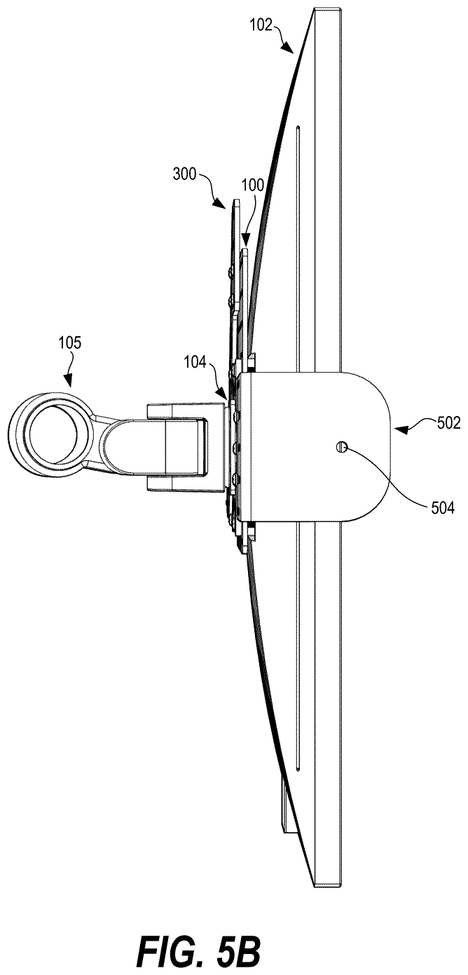

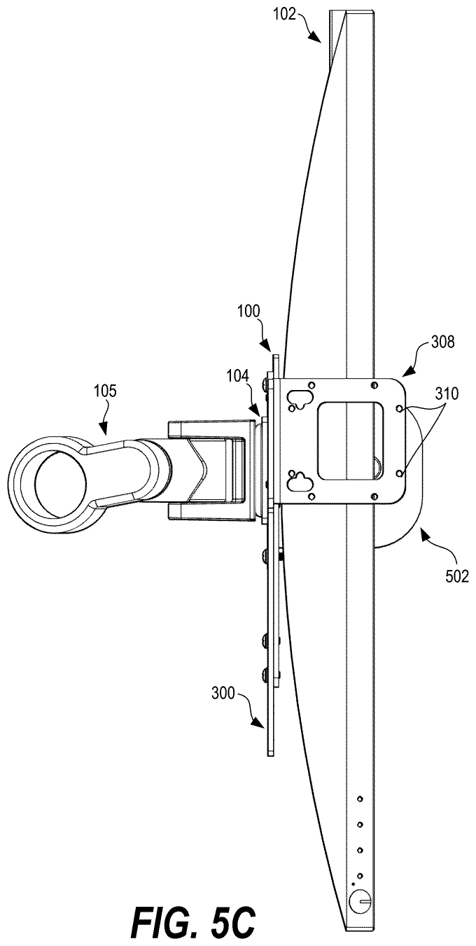

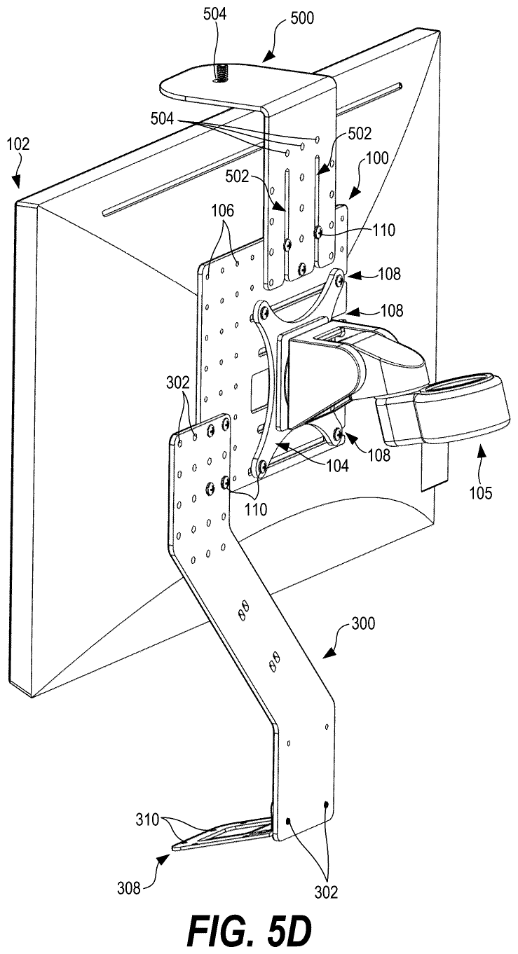

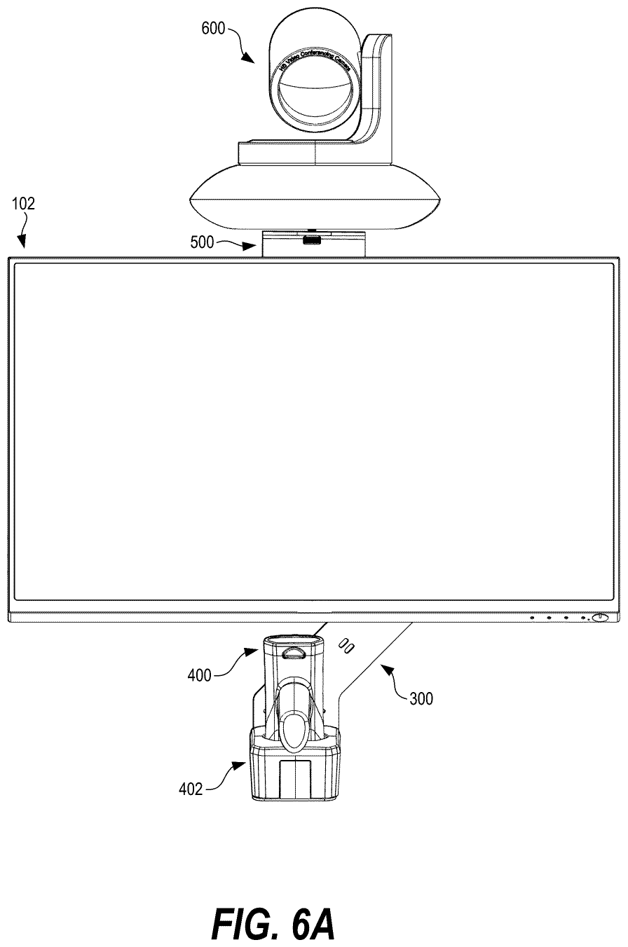

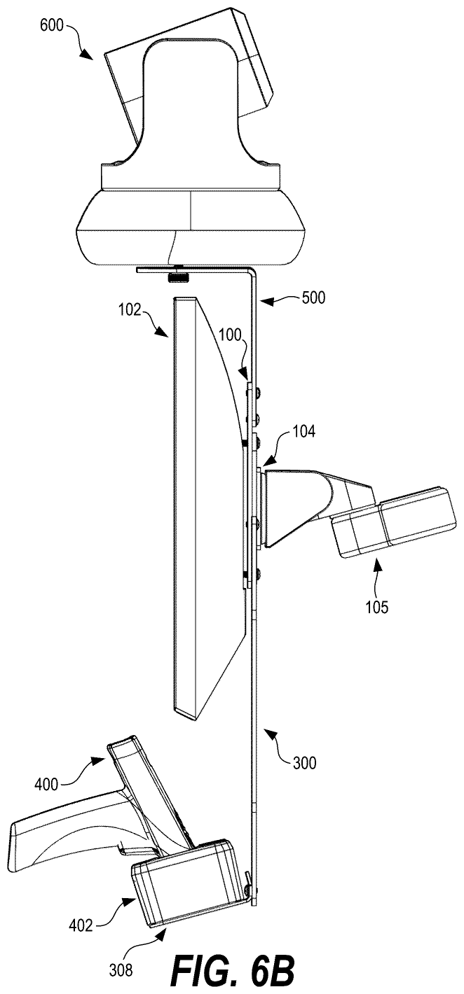

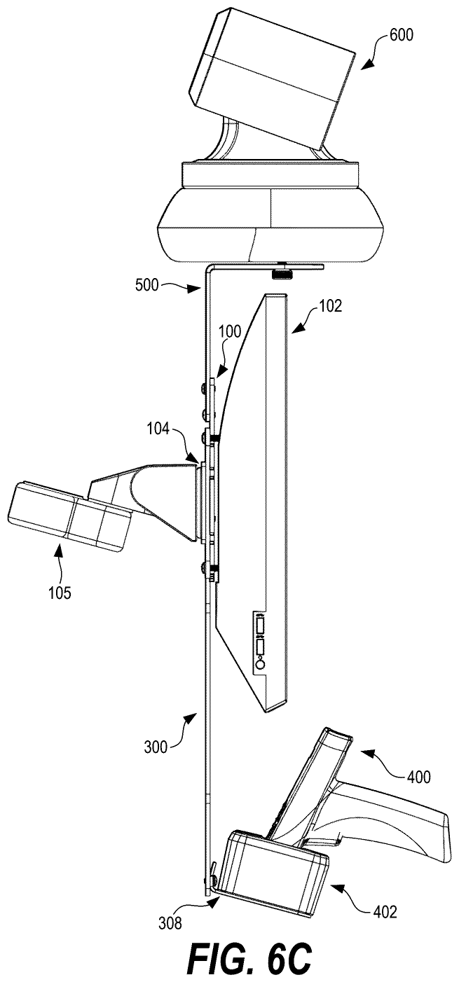

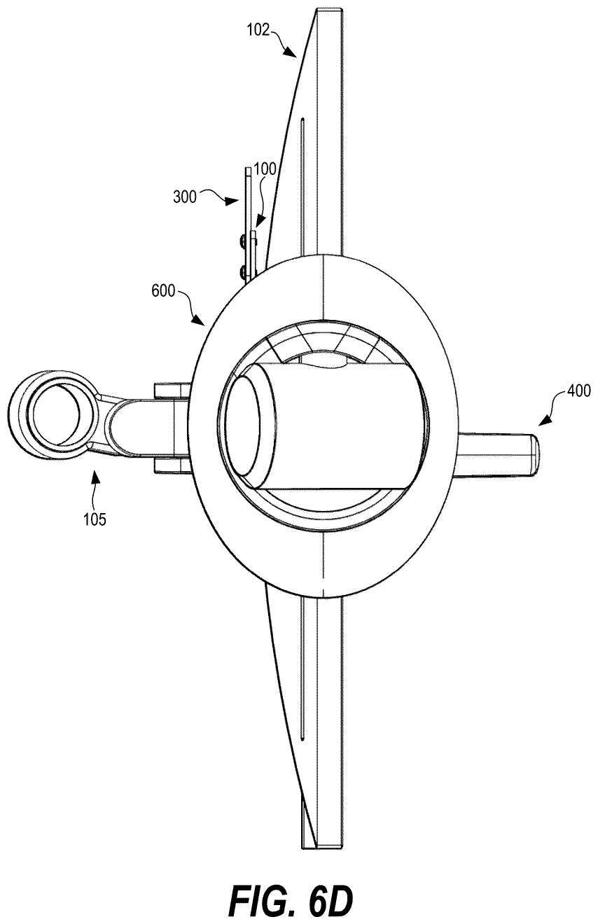

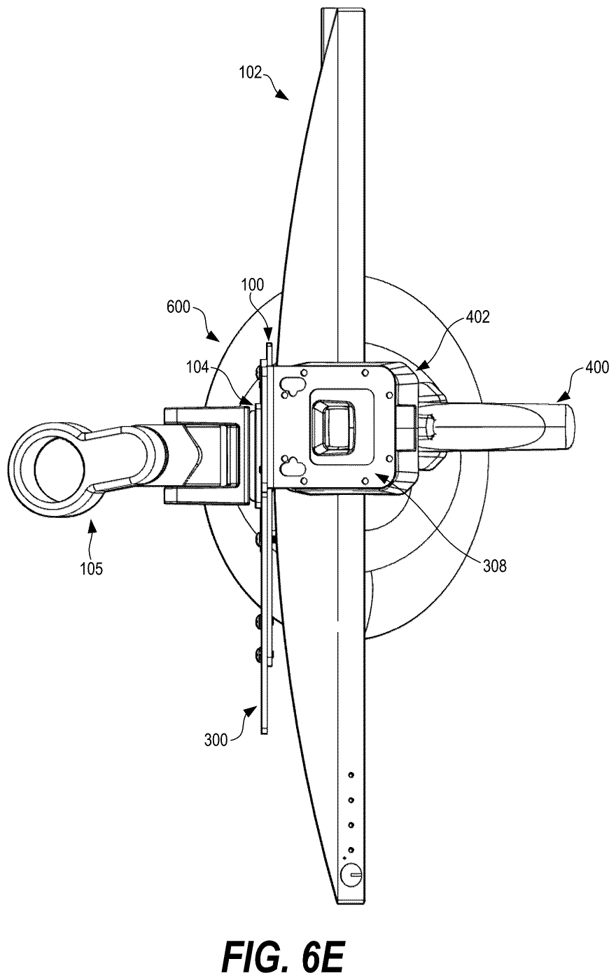

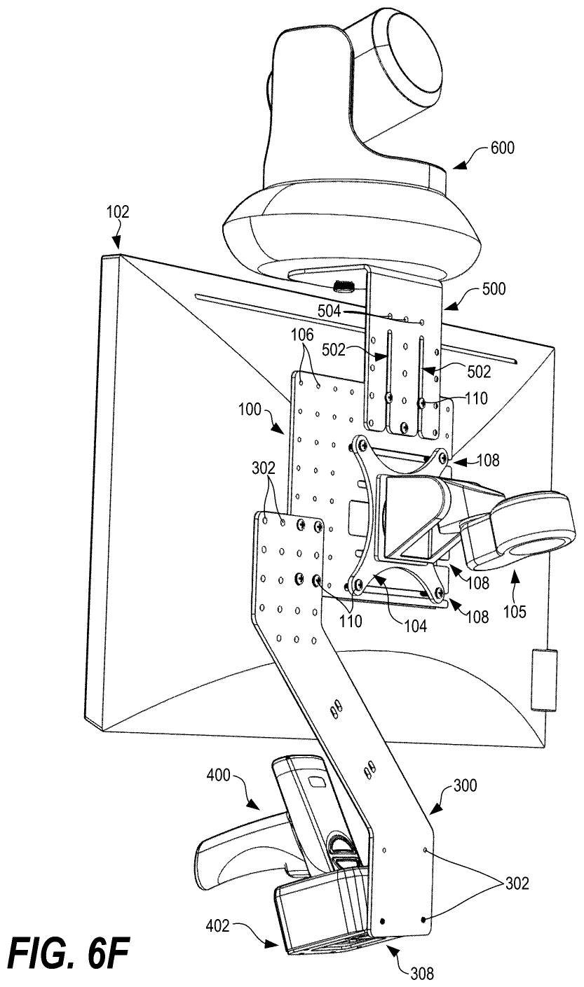

Turning to FIGS. 5A-5D, shown are various views of a camera mount 500 attached to the attachment base 100 along with the scanner mount 308 attached to the accessory arm 300. The camera mount 500 allows a camera (600 shown in FIGS. 6A-6E) to be attached to the monitor 102 in a stable and adjustable manner. The camera mount 500 is attached to the attachment base 100 but alternatively may be attached to the accessory arm 300.

FIG. 5A depicts a back view of the configuration. The camera mount 500 is attached to the attachment base 100 using multiple coupling elements 110, shown engaging through camera mount slots 502. The attachment base 100 is mounted between the monitor 102 and the support structure 104. The camera mount 500 extends upwards, with several camera mount holes 504 designed to secure a camera or other accessories to the camera mount 50. Additionally, the accessory arm 300 extends downward from the attachment base 100, holding the scanner mount 308.

FIG. 5B depicts a top view of the configuration, highlighting the compact arrangement of the camera mount 500 above the monitor 102. The camera mount 500 is depicted with its top portion extending beyond the attachment base 100, providing a clear view of its upward extension and how it secures to the monitor 102. The camera mount 500 includes a camera mount hole 504. In one example a thumb screw or similar fastener is fed through the camera mount hole 504 and into a camera or camera base, such as shown in FIGS. 6A-6F.

FIG. 5C depicts a bottom view of the configuration, focusing on the alignment of the various components. The attachment base 100 is installed between the support structure 104 and the monitor 102, with the camera mount 500 and the accessory arm 300 extending outward. FIG. 5C illustrates the spatial relationship between the camera mount 500 and the other components.

FIG. 5D depicts a perspective view of the configuration, offering a three-dimensional perspective of how the camera mount 500 is installed on the attachment base 100. The coupling elements 110 are shown inserted through the camera mount slots 502 and into the attachment base holes 106. Similar to how the support structure 104 may be easily installed or removed from the attachment base 100 using the attachment base slots 108, the camera mount 500 may be easily installed or removed from the attachment base 100 using the camera mount slots 502.

Turning to FIGS. 6A-6F, shown are various views of an example configuration where a camera 600 is mounted above the monitor 102, and the scanner 400 is mounted below the monitor 102. The camera 600 is attached to a camera mount 500 that is secured to the attachment base 100 positioned behind the monitor 102, providing a stable platform for the camera 600 above the monitor 102. The scanner 400 is shown on the scanner base 402, which is attached to the accessory arm 300 via the scanner mount 308, extending downward from the attachment base 100. This configuration allows both the camera 600 and the scanner 400 to be positioned for optimal use, with the camera 600 positioned to capture images or video above the monitor 102, and the scanner 400 conveniently accessible below the monitor for scanning tasks. Each of the FIGS. 6A-6F provides a different perspective to illustrated the spatial arrangement and secure attachment of these components around the monitor 102.

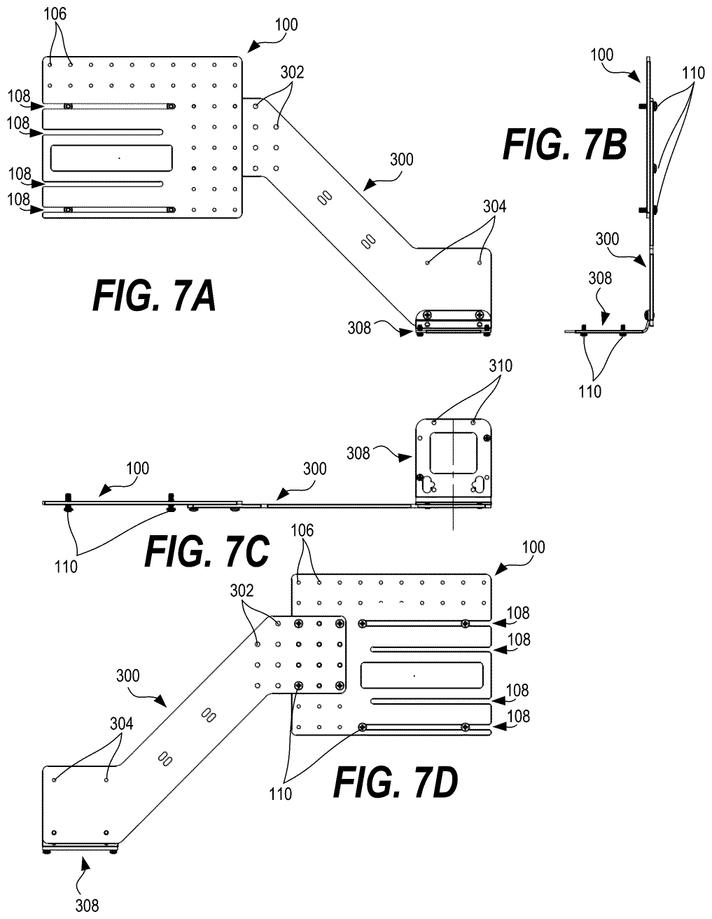

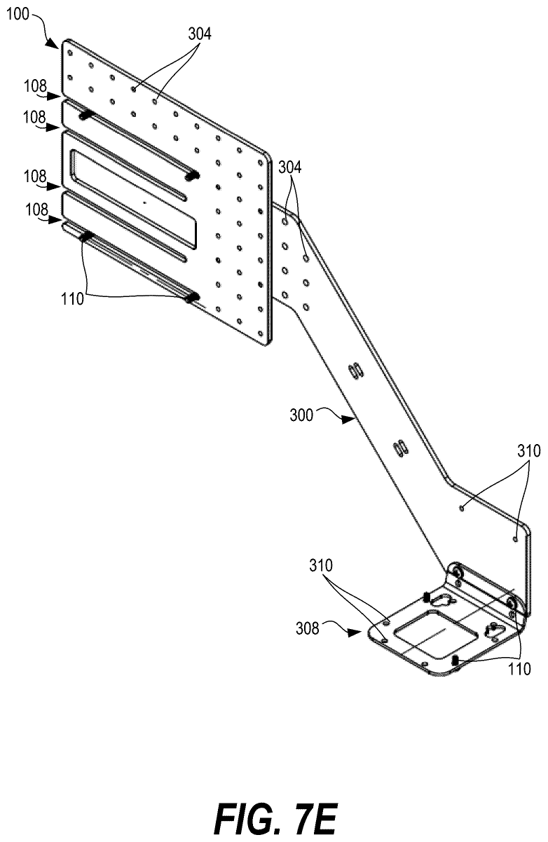

Turning to FIGS. 7A-7E, shown are various views of the attachment base 100 and accessory arm 300 assembly, illustrating different configurations and perspectives of the mounting system. FIG. 7A provides a front view of the attachment base 100 and the accessory arm 300 assembly. The attachment base 100 features multiple attachment base slots 108 and attachment bases holes 106 for securing various components, while the accessory arm 300 extends outwards, providing additional mounting options via accessory arm holes 302 and attachment holes 304. FIG. 7B depicts a side view of the assembly, highlighting the alignment of the attachment base 100 with the accessory arm 300 and the scanner mount 308. FIG. 7C offers a bottom view of the assembly, showing the layout of the attachment base 100, the accessory arm 300, and the scanner mount 308. FIG. 7D is a back view showing the relationship between the attachment base 100 and the accessory arm 300. The attachment base holes 106 and the attachment base slots 108 are clearly shown demonstrating the versatility of the mounting system. FIG. 7E provides a perspective view of the assembly, showing the three-dimensional arrangement of the attachment base 100, the accessory arm 300, and the scanner mount 308. This view highlights the spatial relationship between the different components and how they are configured to provide flexible mounting options for various accessories.

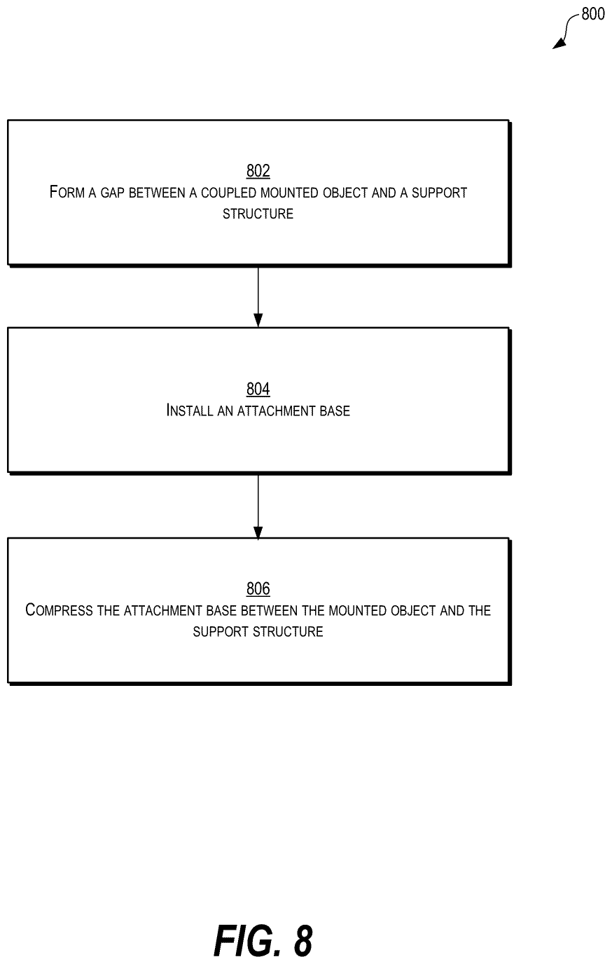

Turning now to FIG. 8, shown is a flow diagram depicting a method 800 for installing an attachment base 100 onto a monitor 102 and securing various add-ons thereto according to an example implementation. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

The method 800 begins at block 802, which involves forming a gap between a coupled mounted object, such as a monitor 102, and a support structure 104. This is achieved by partially loosening one or more coupling elements 110 that secure the mounted object to the support structure 104.

At block 804, an attachment base 100 is installed by sliding it into the gap created at block 802, between the monitor 102 and the support structure 104. The attachment base 100 include one or more attachment base slots 108 that allow the attachment base 100 to be easily aligned and inserted over the partially loosened coupling elements 110.

At block 806, the coupling elements 110 are tightened, compressing the attachment base 100 securely between the monitor 102 and the support structure 104. This compression ensures a stable and secure fit, allowing for various add-ons to be mounted onto the attachment base 100 without the need for further disassembly of the mount system.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described implementations of the present disclosure are merely possible examples set forth for a clear understanding of the principles of the disclosure. Many variations and modifications may be made to the above-described implementations without departing substantially from the spirit and principles of the disclosure. All such modifications and variations are intended to be included herein within the scope of this disclosure and protected by the following claims.

What is claimed is:

1. A mounting assembly for attaching an add-on to a display device, comprising:
an attachment base configured to be positioned between a display device and a support structure, the attachment base comprising a plurality of attachment base holes and one or more attachment base slots, wherein the attachment base is configured to receive one or more coupling elements that secure the attachment base to the display device and the support structure without requiring a complete disassembly of the display device from the support structure.

2. The mounting assembly of claim 1, wherein the one or more attachment base slots are elongated openings extending from an edge of the attachment base towards a central portion of the attachment base.

3. The mounting assembly of claim 1, wherein the attachment base is configured to accommodate multiple types of add-ons.

4. The mounting assembly of claim 1, wherein the attachment base is further configured to allow installation and removal by sliding the attachment base over partially loosened coupling elements.

5. The mounting assembly of claim 1, wherein the attachment base is made from a metal, a plastic, or a composite.

6. The mounting assembly of claim 1, further comprising an add-on mount attachable to the attachment base, the add-on mount comprising additional attachment holes configured to support various add-ons.

7. The mounting assembly of claim 6, wherein the add-on mount is adjustable in both vertical and horizontal directions relative to the attachment base.

8. The mounting assembly of claim 6, wherein the add-on mount is configured to support the add-on.

9. The mounting assembly of claim 1, wherein the attachment base holes are arranged in a grid pattern.

10. The mounting assembly of claim 1, further comprising reinforcement around one or more edges of the one or more attachment base slots to prevent wear and deformation during repeated installations and removals.

11. The mounting assembly of claim 1, wherein the support structure comprises a mount with a standardized configuration of mounting holes.

12. A method for installing an add-on onto a display device, the method comprising:
forming a gap between the display device and a support structure by partially loosening one or more coupling elements;
inserting an attachment base between the display device and the support structure, the attachment base comprising a plurality of attachment base holes and one or more attachment base slots configured to align with the one or more coupling elements; and
tightening the one or more coupling elements to compress the attachment base between the display device and the support structure, securing the attachment base without requiring a complete disassembly of the display device from the support structure.

13. The method of claim 12, further comprising aligning the attachment base slots with the partially loosened coupling elements before inserting the attachment base into the gap.

14. The method of claim 12, further comprising attaching an add-on mount to the attachment base, the add-on mount being configured to support the add-on.

15. The method of claim 14, wherein the add-on mount is adjustable relative to the attachment base to allow repositioning of the add-on.

16. The method of claim 12, further comprising positioning an accessory arm on the attachment base, the accessory arm comprising additional attachment holes for securing various add-ons.

17. A mounting system for attaching one or more add-ons to a display device, comprising:
an attachment base configured to be installed between a display device and a support structure, the attachment base having a plurality of attachment base holes and one or more attachment base slots configured to receive coupling elements;
an accessory arm attachable to the attachment base, the accessory arm comprising additional attachment holes for securing the one or more add-ons; and
an add-on mount attachable to the attachment base, the add-on mount comprising multiple mount slots and holes for versatile attachment of the one or more add-ons; and
wherein the attachment base, the accessory arm, and the add-on mount allow for versatile mounting of the one or more add-ons without requiring a complete disassembly of the display device from the support structure.

18. The mounting system of claim 17, wherein the add-on mount is configured to be attached above, below, or to a side the display device to support the one or more add-ons in various positions.

19. The mounting system of claim 17, wherein the attachment base comprises one or more cable management elements to organize and secure one or more cables.

20. The mounting system of claim 17, wherein the add-on mount comprises a quick-release mechanism to facilitate easy installation and removal of peripheral devices.
